(19) United States
(12) Patent Application Publication
(10) Pub. No.: US 2026/0183169 A1
(43) Pub. Date: Jul. 2, 2026

(54) OPERATING TABLE

(71) Applicant: Nanjing Mindray Bio-Medical Electronics Co., Ltd., Nanjing (CN)

(72) Inventors: Linlin HU, Nanjing (CN); Yundong WANG, Nanjing (CN); Zhaoyu CAI, Nanjing (CN); Changjiang CHEN, Nanjing (CN); Yunfei YAO, Nanjing (CN); Zhengyun YANG, Nanjing (CN); Shaohui XIE, Nanjing (CN)

(21) Appl. No.: 19/436,984

(22) Filed: Dec. 30, 2025

(30) Foreign Application Priority Data
Dec. 30, 2024 (CN) 202411977418.8
Dec. 30, 2024 (CN) 202411980100.5

(51) Int. Cl. A61G 13/06

(52) U.S. Cl. CPC A61G 13/06; A61G 2203/30; A61G 2203/726

(57) ABSTRACT

An operating table is disclosed, including a tabletop; a column; a driving device to drive the column to move upward and downward; a protective cover arranged outside the column and covers the column, wherein the protective cover is capable of moving upward and downward along the first direction, while the column moves upward and downward; at least one detection component, which comprises a first element arranged at the protective cover, and configured to transmit a signal along a signal transmission path; and a control device; wherein while the column moves upward and downward, the control device is configured to control the driving device for the column to stop driving the column and/or the control device is configured to send an alarm signal, when the signal transmission path is blocked. The operating table effectively prevents the protective cover from being damaged due to collision or pressing with an external object.

### CROSS-REFERENCE TO RELATED APPLICATIONS

The application is based on a Chinese patent application No. 202411980100.5, filed on Dec. 30, 2024, and claims priority to said Chinese patent application; the content of which is incorporated herein by reference in its entirety.

The application is further based on a Chinese patent application No. 202411977418.8, filed on Dec. 30, 2024, and claims priority to said Chinese patent application; the content of which is incorporated herein by reference in its entirety.

### TECHNICAL FIELD

The disclosure relates to the technical field of medical devices, and more particularly to an operating table.

### BACKGROUND OF THE DISCLOSURE

In related technologies, a protective cover is usually installed outside a column of an operating table. While lift the operating table, the protective cover moves up and down along with a tabletop to protect the column. However, during a surgical process, it is common for medical staff to place accessories for the operating table (such as a hand support, a leg support, and a body support), non-sterile items used during a surgery (such as a wired controller, a remote controller, a hospital gown, a sterile sheet), etc., into a region, which is below the protective cover. When moving the tabletop up and down, the protective cover is prone to collision or pressing with these external objects, resulting in damage.

### SUMMARY OF THE DISCLOSURE

Based on these, an embodiment of this disclosure aims to provide an operating table, which is capable of effectively preventing collision or pressing between a protective cover and an external object.

To achieve an above objective, an embodiment of this disclosure provides an operating table including:
a tabletop;
a column, which supports the tabletop, wherein the column is capable of moving upward and downward along a first direction;
a driving device for the column, which is configured to drive the column to move upward and downward, so as to adjust a height of the tabletop;
a base, which is arranged at a bottom of the column;
a protective cover, which is arranged outside the column and covers the column, wherein the protective cover is capable of moving upward and downward along the first direction, while the column moves upward and downward;
at least one detection component, which includes a first element, wherein the first element is arranged at the protective cover, and configured to transmit a signal along a signal transmission path; and
a control device, which is connected with the at least one detection component and the driving device for the column; wherein while the column moves upward and downward, the control device is configured to control the driving device for the column to stop driving the column and/or the control device is configured to send an alarm signal, when the signal transmission path is blocked.

In an embodiment, the signal transmission path extends along a second direction, which intersects with the first direction.

In an embodiment, the second direction is perpendicular to the first direction.

In an embodiment, the at least one detection component further includes a second element, wherein the first element and the second element are arranged with a gap therebetween, wherein the signal is transmitted at least between the first element and the second element.

In an embodiment, the second element is configured to receive the signal, which is transmitted by the first element, so as to transmit the signal at least between the first element and the second element; or
the second element is configured to reflect the signal back to the first element, which signal is transmitted by the first element, and enable the first element to receive the signal reflected, so as to transmit the signal at least between the first element and the second element.

In an embodiment, the first element and the second element are arranged with a gap therebetween along a second direction, which direction intersects with the first direction.

In an embodiment, the protective cover includes a bottom housing that is affixed to the base and at least one cover housing that is movably and foldably sleeved above the bottom housing; wherein the at least one cover housing is capable of moving upward and downward along the first direction, so as to enable the protective cover to move upward and downward along the first direction; wherein both the first element and the second element are arranged at the at least one cover housing.

In an embodiment, the at least one cover housing includes multiple cover housings, and the multiple cover housings are movably and foldably sleeved in sequence, wherein one of the multiple cover housings is a top cover housing, which is connected with the column, while other multiple cover housings are intermediate cover housings, which are arranged between the top cover housing and the bottom housing;
the first element and the second element are arranged at the top cover housing; or
the first element and the second element are arranged at the intermediate cover housing(s).

In an embodiment, the first element and the second element are arranged at a same intermediate cover housing.

In an embodiment, the first element and the second element respectively protrude from a bottom surface of the cover housing.

In an embodiment, the first element is movably arranged at the protective cover, and when the first element moves from a first position to a second position under an external force, the signal transmission path is blocked; and/or
the second element is moveably arranged at the protective cover, and when the second element moves from a third position to a fourth position under an external force, the signal transmission path is blocked.

In an embodiment, the first element moves upward long the first direction, so as to move from the first position to the second position;
the at least one detection component includes a first elastic member, wherein the first elastic member is arranged on a side of the first element, which side back-faces the base, so as to drive the first element to move from the second position to the first position, when the external force is withdrawn; or
the first element moves from the second position to the first position under its own gravity, when the external force is withdrawn.

In an embodiment, the second element moves upward long the first direction, so as to move from the third position to the fourth position;
the at least one detection component includes a second elastic member, wherein the second elastic member is arranged on a side of the second element, which side back-faces the base, so as to drive the second element to move from the fourth position to the third position, when the external force is withdrawn; or
the second element moves from the fourth position to the third position under its own gravity, when the external force is withdrawn.

In an embodiment, the operating table further includes:
a first position-limiting structure, which is configured to limit the first element at the first position and/or the second position; and/or
a second position-limiting structure, which is configured to limit the second element at the third position and/or the fourth position.

In an embodiment, the at least one detection component further includes a third element that is arranged between the first element and the second element, wherein the signal is transmitted between the first element and the second element through the third element.

In an embodiment, the third element transmits the signal by reflecting the signal.

In an embodiment, the first element and the second element are respectively arranged on a same side or different sides of the protective cover along a circumferential direction of the protective cover.

In an embodiment, the at least one detection component includes multiple detection components that are arranged along a circumferential direction of the protective cover, wherein the first element and the second element of each detection component are arranged with a gap therebetween along the circumferential direction of the protective cover.

In an embodiment, at least one of the multiple detection components is a first detection component including a third element; wherein the first element and the second element of the first detection component are respectively arranged on different planes of the protective cover along the circumferential direction of the protective cover, and the third element is arranged between said first element and said second element, so as to enable the signal to be transmitted between said first element and said second element through the third element.

In an embodiment, the protective cover is provided with multiple side surfaces along the circumferential direction of the protective cover, wherein a corner is formed between two adjacent side surfaces;
the first element of at least one of the multiple detection components and the second element of another one of the multiple detection components are respectively arranged on corresponding two adjacent side surfaces, and are adjacent to the corner between the corresponding two adjacent side surfaces.

In an embodiment, respective first elements of one of the multiple detection components and respective second elements of another adjacent one of the multiple detection components are respectively arranged on corresponding two adjacent side surfaces, and are respectively adjacent to the corners between said corresponding two adjacent side surfaces.

In an embodiment, the first element and the second element are arranged with a gap therebetween along the first direction.

In an embodiment, the first element and the second element are both arranged at the protective cover; or
one of the first element and the second element is arranged at the protective cover, and the other one of the first element and the second element is arranged at the base.

In an embodiment, the protective cover includes a bottom housing that is affixed to the base and a cover housing that is movably and foldably sleeved above the bottom housing; wherein the cover housing is capable of moving upward and downward along the first direction, so as to enable the protective cover to move upward and downward along the first direction; wherein one of the first element and the second element is arranged at the cover housing, and the other one of the first element and the second element is arranged at the bottom housing or the base.

In an embodiment, the at least one detection component includes multiple detection components; at least one side of the protective cover is provided with the multiple detection components, which are arranged along a circumferential direction of the protective cover.

In an embodiment, the at least one detection component is one of: an infrared detection component, a radar detection component, and a laser detection component.

An embodiment of this disclosure provides an operating table, in which a first element that transmits signals along a signal transmission path, is arranged at a protective cover outside a column, a control device of the operating table controls a driving device for the column to stop driving the column and/or sends an alarm signal, when the signal transmission path is blocked. That is, when the signal transmission path is blocked, it indicates that a possibility of collision between the protective cover and an external object placed adjacent to the operating table may exist. Therefore, the control device can control the driving device for the column to stop driving the column, or send an alarm signal, which enables the column to stop moving upward or downward immediately and/or enables the control device to send an alarm signal to medical staff, so as to effectively prevent the protective cover from being damaged due to collision or pressing with an external object.

### BRIEF DESCRIPTION OF THE DRAWINGS

FIG. 1 is a structural diagram for a portion of an operating table according to an embodiment of this disclosure, in which, the operating table is in a first detection scenario, and a dashed line with an arrow represents a signal transmission path.

FIG. 2 is a diagram for an operating table shown in FIG. 1, in which, the operating table is in a second detection scenario, and a dashed line with an arrow represents a signal transmission path.

FIG. 3 is a diagram for an operating table shown in FIG. 1, in which, the operating table is in a third detection scenario, and a dashed line with an arrow represents a signal transmission path.

FIG. 4 is an exploded diagram for a top cover housing and a detection component of an operating table shown in FIG. 1.

FIG. 5 is an abbreviated structural diagram for an protective cover and a detection component for a second operating table according to an embodiment of this disclosure, wherein a dashed line with an arrow represents a signal transmission path.

FIG. 6 is a structural diagram for a portion of a third operating table according to an embodiment of this disclosure, in which, a dashed line with an arrow represents a signal transmission path.

FIG. 7 is a structure diagram for an operating table according to an embodiment of this disclosure.

### EXPLANATION FOR REFERENCE NUMBERS

100. Operating table. 10. Base. 20. Protective cover. 20a. Corner. 21. Bottom housing. 22. Cover housing. 22a. Top cover housing. 22b. Intermediate cover housing. 30.
Detection component. 30a. First detection component. 30b. Second detection component. 31. First element. 32. Second element. 33. Third element. 34. First elastic element. 35. Second elastic element. 200. External object.
110. Tabletop 110. 120. Column. 130. Driving device. 140. Base. 150. Protective cover. 160. Detection device. 170. Control device.

### DESCRIPTION OF THE PREFERRED EMBODIMENTS

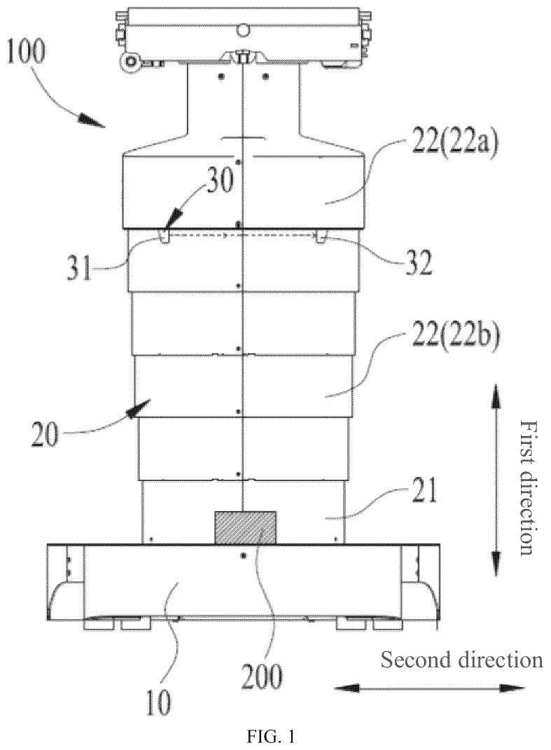

In description for embodiments of this disclosure, it should be noted that the terms “first direction”, “second direction”, etc., indicate orientation or positional relationships based on an orientation or positional relationship shown in FIG. 1. These orientation terms are only for convenience of describing embodiments of this disclosure and simplifying description, and do not indicate or imply that a device or component referred to must have a specific orientation, be constructed and operated in a specific orientation, and therefore cannot be understood as limiting embodiments of this disclosure.

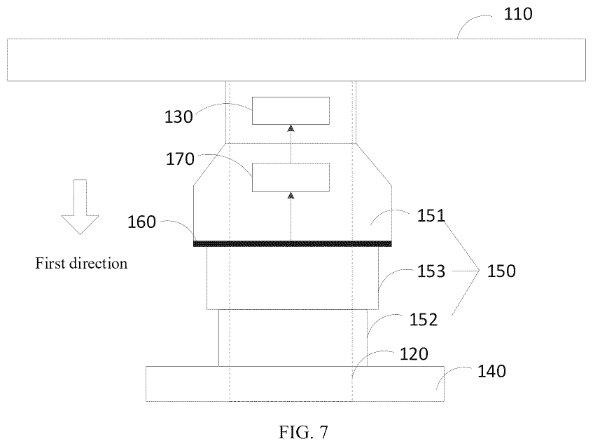

An embodiment of this disclosure provides an operating table 100, as shown in FIG. 1. The operating table 100 includes a tabletop (referring tabletop 110 in FIG. 7), a column (referring column 120 in FIG. 7), a driving device for the column (referring driving device 130 for column 120 in FIG. 7), a base 10, a protective cover 20, a detection component 30, and a control device (referring control device 170 in FIG. 7).

The tabletop is used for a patient to lie down, so as to provide support and stability during a surgical process.

The column supports the tabletop and is capable of moving upward and downward along a first direction. The driving device for the column is configured to drive the column to move upward and downward, so as to adjust a height of the table. The base 10 is arranged at a bottom of the column. The protective cover 20 is arranged outside the column and covers the column, wherein the protective cover 20 is capable of moving upward and downward along the first direction, while the column moves upward and downward, so as to provide a protection for the column.

The detection component 30 includes a first element 31, which is arranged at the protective cover 20, wherein the first element 31 transmits a signal along a signal transmission path.

The detection component 30 utilizes the signal transmitted by the first element 31 to achieve a detection function. The detection component 30 can have only the first element 31, or may have other element(s) that cooperate(s) with the first element 31 in addition to the first element 31.

For example, referring to FIG. 1, the detection component 30 can also be provided with a second element 32, wherein the first element 31 and the second element 32 are arranged with a gap therebetween, so as to enable a signal to be transmitted at least between the first element 31 and the second element 32. That is to say, the second element 32 can be used in cooperation with the first element 31.

Please refer to FIG. 1, the second element 32 is capable of enabling a signal to be at least transmitted between the first element 31 and the second element 32 by receiving a signal, which transmitted by the first element 31, wherein the first element 31 is a transmitting element and the second element 32 is a receiving element. That is to say, the detection component 30 may include a transmitting element and a receiving element, and the signal transmission path at least extends from the first element 31 to the second element 32 that receives the signal.

In another embodiment, the second element 32 can also reflect a signal, which is transmitted by the first element 31, back to the first element 31, so as to enable the first element 31 to receive the reflected signal, in order to enable a signal to be transmitted at least between the first element and the second element. That is to say, the detection component 30 can also include a transmitting and receiving element, and a reflecting element, and a signal transmission path extends from the first element 31 to the second element 32 that reflects the signal, and then returns from the second element 32 to the first element 31.

In addition, a type of detection component 30 is not limited. For example, the detection component 30 can be an infrared detection component, a radar detection component, a laser detection component, etc.

When the detection component 30 is an infrared detection component, the first element 31 transmits an infrared signal.

When the detection component 30 is a radar detection component, the first element 31 transmits an electromagnetic wave signal.

When the detection component 30 is a laser detection component, the first element 31 transmits a laser pulse signal.

The control device is connected with the detection component 30 and the driving device for the column. While the column moves upward and downward, when the signal transmission path is blocked, the control device controls the driving device for the column to stop driving the column and/or sends an alarm signal.

That is to say, while the column moves upward and downward, the first element 31 transmits a signal along the signal transmission path. If the signal transmission path is blocked, that is, the signal transmitted by the first element 31 is blocked and cannot be received by the second element 32, or the signal transmitted by the first element 31 does not reach the second element and/or is not reflected by the second element, but is blocked and/or reflected by an external object, the control device controls the driving device for the column to stop driving the column, thereby stopping the column to move upward and downward, and/or the control device sends an alarm signal to alarm medical staff.

Specifically, when the first element 31 is a transmitting element and the second element 32 is a receiving element, if the signal transmission path between the first element 31 and the second element 32 is blocked, resulting in that the second element 32 is unable to receive a signal, then the control device controls the driving device for the column to stop driving the column and/or the control device sends an alarm signal. When the first element 31 is a transmitting and receiving element, and the second element 32 is a reflecting element, if the signal transmission path between the first element 31 and the second element 32 is blocked, signals transmitted by the first element 31 are blocked by an external object, and a part of the signals are reflected by the external object to the first element 31 and received by the first element 31. The control device can determine that the signal transmission path is blocked based on a strength of the received signals, so as to enable the column to stop moving upward or downward immediately and/or so as to send an alarm signal to medical staff.

Specifically, please refer to FIGS. 1-3. If an external object 200, such as an accessory for the operating table (such as a hand support, a leg support, and a body support), non-sterile items used during a surgery (such as a wired controller, a remote controller, a hospital gown, a sterile sheet), etc., is placed adjacent to the protective cover 20, this external object 200 may block the signal transmission path, while the column moves upward and downward, indicating that a possibility of collision between the protective cover and the external object placed adjacent to the operating table may exist. Therefore, the control device can control the driving device for the column to stop driving the column, or send an alarm signal, which enables the column to stop moving upward or downward immediately and/or enables the control device to send an alarm signal to medical staff, so as to effectively prevent the protective cover from being damaged due to collision or pressing with an external object.

In an embodiment, please refer to FIG. 1, the signal transmission path can extend along a second direction which intersects with the first direction, meaning that an extension direction of the signal transmission path is not parallel to the first direction. Due to the fact that the protective cover 20 moves upward and downward along the first direction, the extension direction of the signal transmission path is not parallel to the first direction, allowing a signal, which is transmitted by the first element 31, to be transmitted inside at least a part of a region, which is along a circumferential direction of the protective cover 20, thereby expanding a detection range of the detection component 30 along the circumferential direction of the protective cover 20 and improving an accuracy of the detection component 30 in detecting the external object 200.

Preferably, the second direction can be perpendicular to the first direction, meaning that the extension direction of the signal transmission path is perpendicular to the first direction.

In another embodiment, the second direction may also obliquely intersect with the first direction.

In an embodiment, referring to FIGS. 1-3, for the detection component 30 with a first element 31 and a second element 32, the first element 31 and the second element 32 can be arranged with a gap therebetween at the protective cover 20 along the second direction.

For example, referring to FIGS. 1-3, the protective cover 20 includes a bottom housing 21, which is affixed to the base 10, and at least one cover housing 22, which is movably and foldably sleeved above the bottom housing 21. The cover housing 22 moves upward and downward along the first direction, so as to enable the protective cover 20 to move upward and downward along the first direction. That is to say, while the column moves upward and downward, the cover housing 22 is capable of moving upward and downward relative to the bottom housing 21 along the first direction, so as to enable the protective cover 20 to move upward and downward along the first direction.

Please continue to refer to FIGS. 1-3. The first element 31 and the second element 32 can be arranged at the cover housing 22, which means that the first element 31 and the second element 32 can move upward and downward together with the cover housing 22. A number of the cover housing 22 can be one or multiple. Please refer to FIG. 1. For a protective cover 20 with multiple cover housings 22, multiple cover housings 22 are foldably sleeved in sequence, and each cover housing 22 can move upward and downward along the first direction.

Please continue to refer to FIGS. 1-3. Among the multiple cover housings 22, one cover housing 22 is a top cover housing 22a, which is connected with the column, and other cover housings 22 are intermediate cover housings 22 arranged between the top cover housing 22 and the bottom cover 21. A number of intermediate cover housings 22 can be one or more.

Please refer to FIGS. 1-3, the first element 31 and the second element 32 can be arranged at the top cover housing 22a.

Specifically, when the column moves upward to an extreme position, a distance between the top cover housing 22a and the base 10 is generally greater than a distance between an intermediate cover housing 22b and the base 10. Therefore, the first element 31 and the second element 32 are arranged at the top cover housing 22a, so as to expand a detection range of the detection component 30 along the first direction, thus enabling the detection component 30 to detect an external object, which is placed at a relatively high height.

In other embodiments, the first element 31 and the second element 32 may also be provided arranged at an intermediate cover housing 22b. When a number of the intermediate cover housings 22b is greater than one, in order to ensure a stable signal transmission between the first element 31 and the second element 32, it is preferred that the first element 31 and the second element 32 are arranged at a same intermediate cover housing 22b.

The first element 31 and the second element 32 are preferably arranged on a bottom surface or an outer periphery surface of a same cover housing 22, and more preferably, protrude from the bottom surface of said cover housing 22, so as to detect an external object, which is arranged below the cover housing 22 and enters into a region between the first element 31 and the second element 32. When an external object blocks the signal transmission path between the first element 31 and the second element 32, the signal transmission path is blocked. The first element 31 and the second element 32 can be arranged at a same cover housing 22.

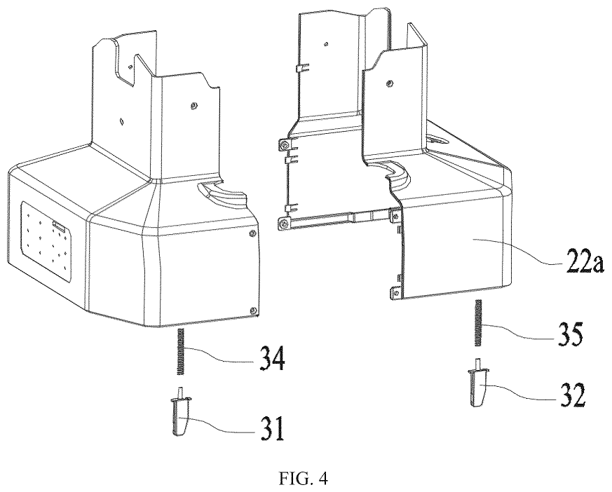

Please continue to refer to FIG. 4. The first element 31 can be movably arranged at the protective cover 20. When the first element 31 moves from a first position to a second position under an external force, a signal transmitted by the first element 31 is blocked, and the signal transmission path is blocked. The first position may be a position, at which position the first element 31 extends from a cover housing 22 and is capable of smoothly transmitting signals to the second element 32, wherein the first element 31 is arranged at said cover housing 22; while the second position may be a position, at which position the first element 31 retracts into a cover housing 22 and/or the first element 31 is not capable of transmitting signals to the second element 32, wherein the first element 31 is arranged at said cover housing 22.

That is to say, the first element 31 can move relative to the protective cover 20 where the first element 31 is arranged. When the first element 31 is at the first position, a signal transmitted by the first element 31 can be transmitted between the first element 31 and the second element 32. When the first element 31 moves from the first position to the second position under an external force, the signal transmitted by the first element 31 cannot be transmitted between the first element 31 and the second element 32 due to a change in position, resulting in the signal being blocked.

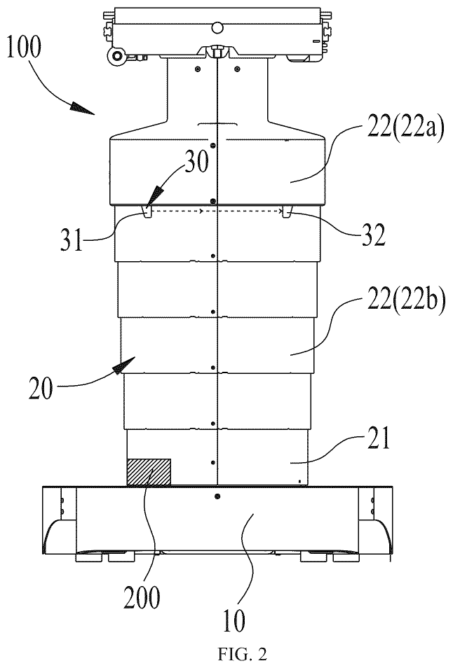

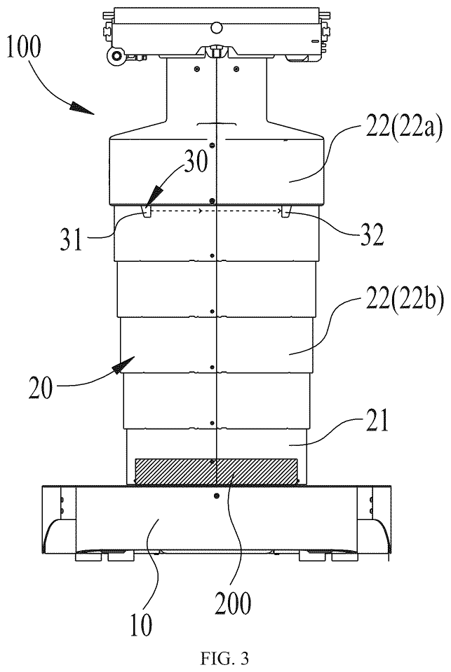

In some scenarios, as the column moves upward or downward, an external object 200 may enter into a region between the first element 31 and the second element 32, block the signal transmitted by the first element 31 (such as an external object 200 shown in FIG. 1). However, in other scenarios, the external object 200 does not enter into a region between the first element 31 and the second element 32. For example, while the column moves upward and downward, the external object 200 may touch the first element 31 (such as an external object 200 shown in FIGS. 2 and 3). This situation represents that a distance between the external object 200 and the protective cover 20 is too close, and the external object 200 may still collide with the protective cover 20. Therefore, arranging the first element 31 to be movable at the protective cover 20 can be applicable a scenario in which the external object contacts with the first element 31. Specifically, after the first element 31 comes into contact with the external object 200, if the first element 31 moves from the first position to the second position under an action force of the external object 200, the signal transmission path is blocked, causing the control device to control the driving device for the column to stop driving the column.

For example, referring to FIG. 4, the first element 31 can move from the first position to the second position by moving upward along the first direction. That is to say, the external object 200 is arranged below the first element 31. While the column moves downward, when the external object 200 contacts with the first element 31, the external object 200 pushes the first element 31 to move upward along the first direction, so as to enable the first element 31 to move from the first position to the second position.

Please continue to refer to FIG. 4. The detection component 30 can be provided with a first elastic member 34, which is arranged on a side of the first element 31, which side back-faces the base 10, so as to drive the first element 31 to move from the second position to the first position, when the external force is withdrawal. That is to say, after the external object 200 pushes the first element 31 to move to the second position, the first elastic member 34 is pressed to produce an elastic deformation. When the external object 200 separates from the first element 31, the first element 31 can return to the first position under the elastic force of the first elastic member 34, thus facilitating the first element 31 to restore.

In other embodiments, the first elastic member 34 may not be provided. For example, when the external force is withdrawal, the first element 31 can also move from the second position to the first position under its own gravity. That is to say, the first element 31 can also rely on its own gravity to restore.

Furthermore, the operating table 100 can also be provided with a first position-limiting structure, which can be used to limit the first element 31 respectively at the first position and/or the second position, so as to ensure that the first element 31 can be respectively maintained at the first position and the second position.

In other embodiments, the first position-limiting structure may only be used to limit the first element 31 at the first position, or may only be used to limit the first element 31 at the second position.

Please continue to refer to FIG. 4. The second element 32 can also be movably arranged at the protective cover 20. When the second element 32 moves from a third position to a fourth position under an external force, the signal is blocked. The third position may be a position, at which position the second element 32 extends from a cover housing 22 and is capable of receiving or reflecting a signal that is transmitted by the first element 31, wherein the second element 32 is arranged at said cover housing 22; while the fourth position may be a position, at which position the second element 32 retracts from a cover housing 22 and/or the second element 32 is not capable of receiving or reflecting a signal that is transmitted by the first element 31, wherein the second element 32 is arranged at said cover housing 22.

Similar to the first element 31 arranged at the protective cover 20, in some scenarios, the external object 200 may come into contact with the second element 32. Therefore, after the second element 32 comes into contact with the external object 200, if the second element 32 moves from the third position to the fourth position under an action force of the external object 200, the signal transmitted by the second element 32 is blocked, which can also enable the control device to control the driving device for the column to stop driving the column.

The first element 31 and the second element 32 shown in FIG. 4 are both movably arranged at the protective cover 20. It can be understood that when the first element 31 is at the first position and the second element 32 is at the third position, the signal transmitted by the first element 31 can be transmitted between the first element 31 and the second element 32. If the first element 31 moves to the second position, or if the second element 32 moves to the fourth position, or if the first element 31 moves to the second position and the second element 32 moves to the fourth position, the signal transmission path will be blocked. Wherein, there are various ways in which the signal transmission path is blocked when the first element 31 moves to the second position and/or the second element 32 moves to the fourth position. For example, when the first element 31 and/or the second element 32 are collided and pressed by an external object, the first element 31 is pressed to the second position and/or the second element 32 is pressed to the fourth position, the signal transmission path is blocked. Alternatively, sleeve(s) can be configured for the first element 31 and/or the second element 32. When the first element 31 moves to the second position and/or the second element 32 moves to the fourth position, the first element 31 and/or the second element 32 are/is arranged inside the sleeve(s), thereby blocking the signal transmission path.

Of course, it can be understood that in a condition that both the first element 31 and the second element 32 are moveably arranged at the protective cover 20, when an external object enters into a region between the first element 31 and the second element 32 and blocks the signal transmission path, even if the external object does not press the first element 31 or the second element 32 to move, it will still block the signal transmission path.

Please continue to refer to FIG. 4. The detection component 30 may include a second elastic member 35, which is arranged on a side of the second element 32, which side back-faces the base 10, so as to drive the second element 32 to move from the fourth position to the third position, when an external force is withdrawal. That is to say, after the external object 200 pushes the second element 32 to move to the fourth position, the second elastic member 35 is pressed to produce an elastic deformation. When the external object 200 separates from the second element 32, the second element 32 can return to the third position under the elastic force of the second elastic member 35, thus facilitating the second element 32 to restore.

In other embodiments, the second elastic member 35 may not be provided. For example, when the external force is withdrawal, the second element 32 can also move from the fourth position to the third position under its own gravity, that is to say, the second element 32 can also rely on its own gravity to restore.

Furthermore, the operating table 100 can also be provided with a second position-limiting structure, which can be used to limit the second element 32 respectively at the third position and/or the fourth position, so as to better ensure that the second element 32 can remain in either the third position or the fourth position.

In other embodiments, the second position-limiting structure may only be used to limit the second element 32 at the third position, or may only be used to limit the second element 32 at the fourth position.

It should be noted that the first element 31 and the second element 32 are not limited to being both movably arranged at the protective cover 20. In other embodiments, the first element 31 may be movably arranged at the protective cover 20, while the second element 32 is affixed at the protective cover 20, or the second element 32 may be movably arranged at the protective cover 20, while the first element 31 is affixed at the protective cover 20, or both the first element 31 and the second element 32 may be affixed at the protective cover 20.

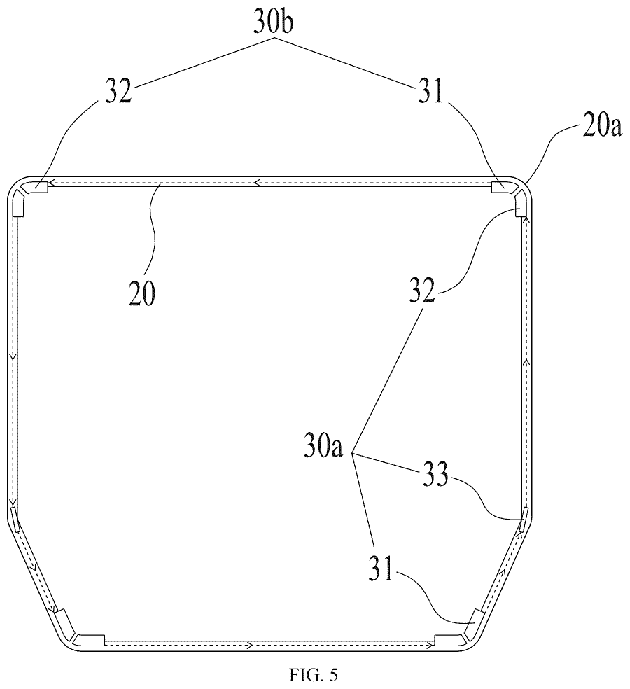

In one embodiment, referring to FIG. 5, in addition to the first element 31 and the second element 32, the detection component 30 may also include a third element 33, which is arranged between the first element 31 and the second element 32, and a signal is transmitted between the first element 31 and the second element 32 via the third element 33. That is to say, the signal transmission path will pass through the third element 33. A number of third elements 33 can be one as shown in FIG. 5, but this disclosure is not limited to this. Multiple third elements 33 can be arranged along a circumferential direction of the protective cover 20.

According to different arrangements, the first element 31 can transmit a signal to the third element 33, and said transmitted signal is transferred to the second element 32 through the third element 33; the first element 31 can also transmit a signal to the third element 33, then said transmitted signal is transferred to the second element 32 through the third element 33, and then the second element 32 can also transfer a received signal to the first element 31 through the third element 33.

Arranging a third element 33 can extend the signal transmission path, which is also beneficial for expanding a detection range of the detection component 30.

Preferably, the third element 33 can transfer a signal by reflecting said signal. That is to say, the third element 33 only plays a role in reflecting a signal. This type of third element 33 can not only effectively transmit a signal, but also have a simple structure and a low cost.

In other embodiments, the third element 33 can also transfer a signal by receiving a signal first and then transmitting a signal, that is to say, the third element 33 is both a signal receiver and a signal transmitter.

Please continue to refer to FIG. 5. The first element 31 and the second element 32 of a same detection component can be arranged on a same side of the protective cover 20, or on different sides of the protective cover 20 along a circumferential direction of the protective cover 20. The different sides can be adjacent sides or any two sides separated by other side(s) (including but not limited to opposite sides), so as to enable a detection range of the detection component 30 to cover at least two sides of the protective cover 20 along the circumferential direction of the protective cover 20, and further expand the detection range of the detection component 30 along the circumferential direction of the protective cover 20.

In one embodiment, referring to FIG. 5, multiple detection components 30 can be arranged along the circumferential direction of the protective cover 20. That is to say, two or more detection components 30 can be arranged along the circumferential direction of the protective cover 20. The first element 31 and the second element 32 of each detection component 30 are arranged with a gap therebetween along the circumferential direction of the protective cover 20. This arrangement method can also detect at least two different sides of the protective cover 20 along the circumferential direction of the protective cover 20, thereby expanding the detection range of the detection components 30 along the circumferential direction of the protective cover 20.

For example, referring to FIG. 5, at least one detection component 30 among multiple detection components 30 may be a first detection component 30a with a third element 33, wherein one side surface of the protective cover 20 is not a flat surface, but has an angle. The first element 31 and the second element 32 of the first detection component 30a are arranged on different planes of a same side surface of the protective cover 20 along the circumferential direction of the protective cover 20, while the third element 33 of the first detection component 30a is arranged outside the angle. The third element 33 may be, for example, a reflective element, used to reflect a signal transmitted by the first element 31 to the second element 32. In addition, all detection components 30 can be the first detection component 30a with the third element 33, or only a part (at least one) of the detection components 30 can be the first detection component 30a with the third element 33, while other detection components 30 are a second detection component 30b just having the first element 31 and the second element 32, but not having the third element 33, depending on a shape of the protective cover.

It should be noted that both the first detection component 30a and the second detection component 30b are detection components 30, and their names have been distinguished for ease of description.

By arranging the first detection component 30a, it is possible to expand the detection range of the detection component 30 along the circumferential direction of the protective cover 20 as much as possible while reducing a total number of detection components 30. This not only facilitates the arrangement of each detection component 30, but also saves production costs.

In other embodiments, all detection components 30 may also be second detection components 30b without a third element 33.

Please continue to refer to FIG. 5. The protective cover 20 has multiple side surfaces along the circumferential direction of the protective cover 20, wherein a corner 20a is formed between two adjacent side surfaces. Preferably, a first element 31 of at least one detection component 30 and a second element 32 of another one detection component 30 can be respectively arranged on corresponding two adjacent side surfaces, and be adjacent to the corner between the corresponding two adjacent side surfaces. That is to say, the first element 31 of one detection component 30 can be as close as possible to the second element 32 of another one detection component 30, so as to enable an effective detection adjacent to the corresponding two adjacent side surfaces of the protective cover 20 and the corner between the corresponding two side surfaces of the protective cover 20.

More preferably, referring to FIG. 5, respective first elements 31 of one detection component 30 and respective second elements 32 of another adjacent detection component 30 can be respectively arranged at corresponding two adjacent side surfaces, and respectively adjacent to respective corners 20a between said two corresponding adjacent side surfaces, so as to enable signal transmission paths of each detection component 30 to jointly surround the circumferential direction of the protective cover 20, which is equivalent to that a combination of the detection range of multiple detection components 30 covers almost all regions of the protective cover 20 along the circumferential direction the protective cover 20, thus providing more comprehensive collision protection for the protective cover 20.

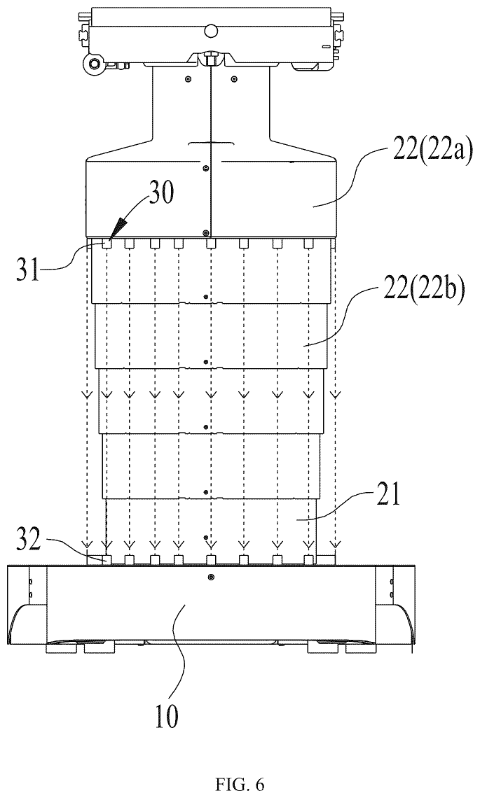

In one embodiment, referring to FIG. 6, the first element 31 and the second element 32 can also be arranged with a gap therebetween along the first direction, which means that the detection component 30 can also detect the external object 200 in the first direction.

For example, the first element 31 and the second element 32 can both be arranged at the protective cover 20. For example, as shown in FIG. 6, for a protection cover 20 with a bottom housing 21 and a cover housing 22, the first element 31 can be arranged at the cover housing 22, and the second element 32 can be arranged at the bottom housing 21. When there are multiple cover housings 22, the first element 31 can be arranged at the top cover housing 22 or at an intermediate cover housing 22.

In other embodiments, the second element 32 may also be arranged at the cover housing 22, and the first element 31 may be arranged at the bottom housing 21. When multiple cover housings 22 exist, the second element 32 may be arranged at the top cover housing 22 or at an intermediate cover housing 22.

In other embodiments, both the first element 31 and the second element 32 may be arranged at an intermediate cover housing 22b.

For example, one of the first element 31 and the second element 32 can also be arranged at the protective cover 20, with the other of the first element 31 and the second element 32 can be arranged at the base 10. For example, for a protective cover 20 with a bottom housing 21 and a cover housing 22, one of the first element 31 and the second element 32 can be arranged at the cover housing 22, the other of the first element 31 and the second element 32 can be arranged at the base 10. When multiple cover housings 22 exist, one of the first element 31 and the second element 32 can be arranged at the top cover housing 22 or at the intermediate cover housing 22.

Please continue to refer to FIG. 6. Multiple detection components 30 can be arranged on at least one side of the protective cover 20 along the circumferential direction of the protective cover 20, and the multiple detection components 30 can be arranged along the circumferential direction of the protective cover 20 to expand the detection range of the detection components 30 along the circumferential direction of the protective cover 20 as much as possible.

Preferably, multiple detection components 30 can be arranged on each side of the protective cover 20 along the circumferential direction of the protective cover 20, so as to enable all detection components 30 to jointly detect almost all regions of the protective cover 20 along the circumferential direction of the protective cover 20, thereby providing more comprehensive collision protection for the protective cover 20.

In other embodiments, a number of detection components 30 may be one, in which the first element 31 and the second element 32 may be arranged with a gap therebetween along the first direction.

In addition, the detection components 30 introduced in the above embodiments can also be combined as needed to satisfy different detection requirements.

FIG. 7 is a structure diagram for an operating table according to an embodiment of this disclosure. As shown in FIG. 7, the operating table according to an embodiment of this disclosure includes a tabletop 110; a column 120, which supports the tabletop 110; a driving device 130 for the column 120, which is configured to drive the column 120 to move upward and downward along a first direction, so as to adjust a height of the tabletop 110; a base 140, which is arranged at a bottom of the column 120 and configured to support the column 120; at least two protective covers 150 for the column 120, which protective covers are sleeved outside the column 120, wherein respective cross-sectional areas of the at least two protective covers 150 for the column 120 decrease from top to bottom in sequence; a detection device 160, which is arranged at at least one target protective cover for the column within the at least two protective covers 150 for the column 120, wherein the detection device 160 protrudes from a bottom of the target protective cover 150 for the column 120 along the first direction; wherein the detection device 160 is configured to transmit a trigger signal, when the detection device 160 is pressed by an obstacle; a control device 170, which is connected with driving device 130 for the column 120 and the detection device 160, wherein the control device 170 is configured to control the driving device 130 for the column 120 to drive the column 120 to move upward or downward, and is configured to identify the obstacle between protective cover 150 for the column 120 and base 140 based on the trigger signal.

Specifically, the tabletop 110 is a component that supports a body of a patient during the surgical process. The tabletop 110 can be composed of multiple support boards that support different parts of the body of the patient. For example, the tabletop 110 includes a back-board, a seat-board, and leg-boards, wherein the leg boards and the backboard are arranged at opposite ends of the seat-board, wherein the seat-board is supported above the column 120. In some embodiments, the tabletop 110 may also include a waist-bridge board, which is positioned between the seat-board and the back-board. For example, the support boards can rotate relative to each other.

The column 120 is arranged below the tabletop 110, and the column 120 is configured to move upward and downward along the first direction under a driving of the driving device 130 for the column 120, thereby driving the tabletop 110 to move upward and downward, in order to adjust a height of the tabletop 110. The first direction can be a vertical direction. The column 120 can be directly connected with the tabletop 110, or indirectly connected with the tabletop 110 through a structure, such as an axle frame, without limitation. For example, the column 120 includes a fixing column and a lifting column, wherein the driving device 130 for the column 120 includes a lifting oil cylinder. A bottom end of the fixing column is fixedly connected with the base 140, and the lifting oil cylinder drives the lifting column to move upward and downward relative to the fixing column. For example, the base 140 may include casters for facilitating a movement of the operating table, and may further include a brake locking component for limiting a movement of the operating table.

At least two protective covers 150 for the column 120 are sleeved outside the column 120 to protect the column 120 and also facilitate to cover an electrical component, circuit, etc. At least two protective covers 150 for the column 120 are a stacked structure with a larger top and a smaller bottom. While the column 120 moves upward and downward, the protective covers 150 for the column 120 will also stretch out and retract back to adapt to a height change of the column 120. As respective cross-sectional areas of at least two protective covers 150 for the column 120 decrease from top to bottom, while the column 120 moves downward, a lower protective cover 150 for the column 120 will be accommodated inside an upper protective cover 150 for the column 120.

For example, the protective cover 150 for the column 120 at least includes a top protective cover 151 for the column 120, which top protective cover 151 is adjacent to the tabletop 110. For example, the top protective cover 151 for the column 120 is fixedly connected with the tabletop 110, that is, while the column 120 drives the tabletop 110 to move upward and downward, the top protective cover 151 for the column 120 moves upward and downward synchronously with the tabletop 110. The top protective cover 151 for the column 120 is an outermost protective cover for the column, and when the column 120 is at any height, the top protective cover 151 for the column 120 is always exposed outside.

Furthermore, the protective cover 151 for the column 120 includes a bottom protective cover 152 for the column 120, which protective cover 152 is adjacent to the base 140. Relative movement can occur between the bottom protective cover 152 for the column 120 and the top protective cover 151 for the column 120. For example, the bottom protective cover 152 for the column 120 is fixedly connected with the base 140, that is, while the column 120 drives the tabletop 110 to move upward and downward, there will be no relative movement between the bottom protective cover 152 for the column 120 and the base 140, and the bottom protective cover 152 for the column 120 will not move upward or downward with the tabletop 110. The bottom protective cover 152 for the column 120 is an innermost protective cover 150 for the column 120. When the column 120 moves downward to an extreme position, at least a portion of the bottom protective cover 152 for the column 120 is stored inside the top protective cover 151 for the column 120.

In some embodiments, the protective cover 151 for the column 120 further includes at least one intermediate protective cover 153 for the column 120, which intermediate protective cover 153 is arranged between the top protective cover 151 for the column 120 and the bottom protective cover 152 for the column 120. Relative movement can occur between the intermediate protective cover 153 for the column 120, the top protective cover 151 for the column 120, and the bottom protective cover 152 for the column 120. The bottom protective cover 152 for the column 120 and each intermediate protective cover 153 for the column 120 can be inserted, sleeved and accommodated inside the top protective cover 151 for the column 120 in sequence.

When the column 120 moves upward to a highest position, the tabletop 110 is at a highest height, the protective cover 150 for the column 120 extends to its longest length, wherein the top protective cover 151 for the column 120, the bottom protective cover 152 for the column 120, and the intermediate protective cover 153 for the column 120 are all exposed to an external view. When the column 120 moves downward to a lowest position, the tabletop 110 is at a lowest height, and the protective cover 150 for the column 120 retracts to a shortest length. The bottom protective cover 152 for the column 120 and the intermediate protective cover 153 for the column 120 are inserted, sleeved and accommodated inside the top protective cover 151 for the column 120 in sequence, with only the top protective cover 151 for the column 120 exposed.

Due to a gradual decrease in a width of each layer of the protective cover 150 for the column 120 from top to bottom, if an obstacle is placed adjacent to the bottom protective cover 152 for the column 120, the obstacle blocks the top protective cover 151 for the column 120 or the intermediate protective cover 153 for the column 120, when the column 120 drives the tabletop 110 to move downward. If continue to drive the tabletop 110 to move downward, the obstacle will press the protective cover 150 for the column 120, causing damage or detachment of the protective cover 150 for the column 120. For this purpose, the embodiment of this disclosure provides a detection device 160 at at least one target protective cover 150 for the column 120, wherein the detection device 160 is configured to transmit a trigger signal, when being pressed by the obstacle, and to identify the obstacle based on the trigger signal.

The operating table of the embodiment of this disclosure is provided with a detection device at the target protective cover for the column. The detection device transmits a trigger signal when the detection device is pressed by an obstacle, and identifies the obstacle around the target protective cover for the column based on the trigger signal, thereby avoiding damage to the target protective cover for the column due to the obstacle, when the tabletop moves downward. In addition, the detection device protrudes from a bottom of the target protective cover for the column along the first direction, such that the detection device can contact with the obstacle before the target protective cover for the column, so as to detect the obstacle before the obstacle collides with the target protective cover for the column, thereby improving an anti-collision effect on the target protective cover for the column.

In the description of this disclosure, reference terms, such as “in an embodiment”, “in some embodiments”, “in other embodiments”, or “exemplary” means that specific features, structures, materials, or characteristics described in cooperation with that embodiment or example are included in at least one embodiment or example of this disclosure. In this disclosure, illustrative expressions of the above terms do not necessarily refer to same embodiments or examples. Moreover, the specific features, structures, materials, or characteristics described can be combined in any one or more embodiments or examples in an appropriate manner. In addition, technicians in this field can combine different embodiments or examples described in this disclosure, as well as features of different embodiments or examples described in this disclosure, without conflicting with each other.

The above embodiments only describe several preferable embodiments of this disclosure, but it cannot be understood as limiting the present disclosure. For those skilled in the art, various modifications and improvements can be made. Any modification and improvement without departing from the concept of this disclosure, still belong to the protection scope of this disclosure.

What is claimed is:

1. An operating table, comprising:
a tabletop;
a column, which supports the tabletop, wherein the column is capable of moving upward and downward along a first direction;
a driving device for the column, which is configured to drive the column to move upward and downward, so as to adjust a height of the tabletop;
a base, which is arranged at a bottom of the column;
a protective cover, which is arranged outside the column and covers the column, wherein the protective cover is capable of moving upward and downward along the first direction, while the column moves upward and downward;
at least one detection component, which comprises a first element, wherein the first element is arranged at the protective cover, and configured to transmit a signal along a signal transmission path; and
a control device, which is connected with the at least one detection component and the driving device for the column; wherein while the column moves upward and downward, the control device is configured to control the driving device for the column to stop driving the column and/or the control device is configured to send an alarm signal, when the signal transmission path is blocked.

2. The operating table according to claim 1, wherein the signal transmission path extends along a second direction, which intersects with the first direction; wherein the second direction is perpendicular to the first direction.

3. The operating table according to claim 1, wherein the at least one detection component further comprises a second element, wherein the first element and the second element are arranged with a gap therebetween, wherein the signal is transmitted at least between the first element and the second element.

4. The operating table according to claim 3, wherein the second element is configured to receive the signal, which is transmitted by the first element, so as to transmit the signal at least between the first element and the second element; or
the second element is configured to reflect the signal back to the first element, which signal is transmitted by the first element, and enable the first element to receive the signal reflected, so as to transmit the signal at least between the first element and the second element.

5. The operating table according to claim 3, wherein the first element and the second element are arranged with a gap therebetween along a second direction, which direction intersects with the first direction.

6. The operating table according to claim 5, wherein the protective cover comprises a bottom housing that is affixed to the base and at least one cover housing that is movably and foldably sleeved above the bottom housing; wherein the at least one cover housing is capable of moving upward and downward along the first direction, so as to enable the protective cover to move upward and downward along the first direction; wherein both the first element and the second element are arranged at the at least one cover housing.

7. The operating table according to claim 6, wherein the at least one cover housing comprises multiple cover housings, and the multiple cover housings are movably and foldably sleeved in sequence, wherein one of the multiple cover housings is a top cover housing, which is connected with the column, while other multiple cover housings are intermediate cover housings, which are arranged between the top cover housing and the bottom housing;
the first element and the second element are arranged at the top cover housing; or
the first element and the second element are arranged at the intermediate cover housing(s).

8. The operating table according to claim 7, wherein the first element and the second element are arranged at a same intermediate cover housing; and/or
the first element and the second element respectively protrude from a bottom surface of the cover housing.

9. The operating table according to claim 5, wherein the first element is movably arranged at the protective cover, and when the first element moves from a first position to a second position under an external force, the signal transmission path is blocked; and/or
the second element is moveably arranged at the protective cover, and when the second element moves from a third position to a fourth position under an external force, the signal transmission path is blocked.

10. The operating table according to claim 9, wherein the first element moves upward long the first direction, so as to move from the first position to the second position;
the at least one detection component comprises a first elastic member, wherein the first elastic member is arranged on a side of the first element, which side back-faces the base, so as to drive the first element to move from the second position to the first position, when the external force is withdrawn; or
the first element moves from the second position to the first position under its own gravity, when the external force is withdrawn.

11. The operating table according to claim 9, wherein the second element moves upward long the first direction, so as to move from the third position to the fourth position;
the at least one detection component comprises a second elastic member, wherein the second elastic member is arranged on a side of the second element, which side back-faces the base, so as to drive the second element to move from the fourth position to the third position, when the external force is withdrawn; or
the second element moves from the fourth position to the third position under its own gravity, when the external force is withdrawn.

12. The operating table according to claim 9, further comprising:
a first position-limiting structure, which is configured to limit the first element at the first position and/or the second position; and/or
a second position-limiting structure, which is configured to limit the second element at the third position and/or the fourth position.

13. The operating table according to claim 3, wherein the at least one detection component further comprises a third element that is arranged between the first element and the second element, wherein the signal is transmitted between the first element and the second element through the third element.

14. The operating table according to claim 13, wherein the third element transmits the signal by reflecting the signal; and/or
the first element and the second element are respectively arranged on a same side or different sides of the protective cover along a circumferential direction of the protective cover.

15. The operating table according to claim 3, wherein the at least one detection component comprises multiple detection components that are arranged along a circumferential direction of the protective cover, wherein the first element and the second element of each detection component are arranged with a gap therebetween along the circumferential direction of the protective cover.

16. The operating table according to claim 15, wherein at least one of the multiple detection components is a first detection component comprising a third element; wherein the first element and the second element of the first detection component are respectively arranged on different planes of the protective cover along the circumferential direction of the protective cover, and the third element is arranged between said first element and said second element, so as to enable the signal to be transmitted between said first element and said second element through the third element.

17. The operating table according to claim 15, wherein the protective cover is provided with multiple side surfaces along the circumferential direction of the protective cover, wherein a corner is formed between two adjacent side surfaces;
the first element of at least one of the multiple detection components and the second element of another one of the multiple detection components are respectively arranged on corresponding two adjacent side surfaces, and are adjacent to the corner between the corresponding two adjacent side surfaces.

18. The operating table according to claim 17, wherein respective first elements of one of the multiple detection components and respective second elements of another adjacent one of the multiple detection components are respectively arranged on corresponding two adjacent side surfaces, and are respectively adjacent to the corners between said corresponding two adjacent side surfaces.

19. The operating table according to claim 3, wherein the first element and the second element are arranged with a gap therebetween along the first direction.

20. The operating table according to claim 19, wherein the first element and the second element are both arranged at the protective cover; or
one of the first element and the second element is arranged at the protective cover, and the other one of the first element and the second element is arranged at the base; or
the protective cover comprises a bottom housing that is affixed to the base and a cover housing that is movably and foldably sleeved above the bottom housing; wherein the cover housing is capable of moving upward and downward along the first direction, so as to enable the protective cover to move upward and downward along the first direction; wherein one of the first element and the second element is arranged at the cover housing, and the other one of the first element and the second element is arranged at the bottom housing or the base; or
the at least one detection component comprises multiple detection components; at least one side of the protective cover is provided with the multiple detection components, which are arranged along a circumferential direction of the protective cover.
